(19) United States
(12) Patent Application Publication
(10) Pub. No.: US 2025/0130785 A1
(43) Pub. Date: Apr. 24, 2025

(54) Enterprise Device Smart Clone

(71) Applicant: Omnissa, LLC, Mountain View, CA (US)

(72) Inventors: MAKRAND SETHI, Bangalore (IN); ANIKETHANA NARASIMHA MURTHY, Palo Alto, CA (US); BASALINGAYYA KARAMADI, Bangalore (IN); PARTHEEBAN KANDASAMY, Sammamish, WA (US); ANOOP ADUR, Bangalore (IN)

(21) Appl. No.: 18/607,369

(22) Filed: Mar. 15, 2024

(30) Foreign Application Priority Data
Oct. 18, 2023 (IN) 202341071005

(51) Int. Cl. G06F 8/61

(52) U.S. Cl. CPC G06F 8/61

(57) ABSTRACT

Disclosed are various approaches for cloning the device state of one device onto another. First, a device state of a first device can be obtained, where the device state includes a plurality of state features. Next, a prompt to select one or more preferred features from the plurality of state features can be generated. Then, a selection of one or more preferred features can be received. Finally, the one or more preferred features can be pushed to a second device.

### CROSS-REFERENCES

This application claims the benefit of Indian Patent Application number 202341071005, entitled “ENTERPRISE DEVICE SMART CLONE,” filed on Oct. 18, 2023, of which is hereby incorporated by reference in its entirety.

### BACKGROUND

As technology rapidly advances, it has become common practice for users to update their laptops, cellphones, or other devices to newer and better models every few years. However, since users often have their current devices set up according to their preferences, it may be difficult to transition from an old device to a new device. For example, setting up a new device according to a user's preferences can be a time-consuming and error-prone process of downloading, installing, and configuring different applications, profiles, certificates, and settings. Additionally, it is common for certain features to be overlooked during this process.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a pictorial diagram of an example user interface rendered by a client according to various embodiments of the present disclosure.

FIG. 2 is a drawing of a network environment according to various embodiments of the present disclosure.

FIG. 3 is a flowchart illustrating one example of functionality implemented as portions of an application executed in a computing environment in the network environment of FIG. 2 according to various embodiments of the present disclosure.

FIG. 4 is a sequence diagram illustrating one example of the interactions between the components of the network diagram of FIG. 2 according to various embodiments of the present disclosure.

### DETAILED DESCRIPTION

Disclosed are various approaches for cloning the device state of one device onto another. There are many circumstances in which users may wish to clone applications, profiles, certificates, settings, or other features from one device to another. For example, in an enterprise digital workspace, users may wish to transfer applications and profiles from one device to another device across various platforms. In another example, a developer may wish to copy the device state from their old laptop to a new laptop. Additionally, users may want to clone applications or profiles among devices as part of a bring-your-own-device (BYOD) program for an enterprise. However, it is a cumbersome task to install applications or profiles one at a time when a user enrolls a new device.

As such, various embodiments of the present disclosure are directed to providing users with simplified systems and methods for cloning applications, profiles, etc. across devices. A user can register multiple devices to a client account. From this account, a user can select a first device to clone onto a second device. A cloning service can then obtain the device state from the first device, present the user with a list of features from the first device, and allow the user to select which features to clone to the second device. Once a user has made their selection, the cloning service can push the selected features to the second device, causing them to be installed and configured.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

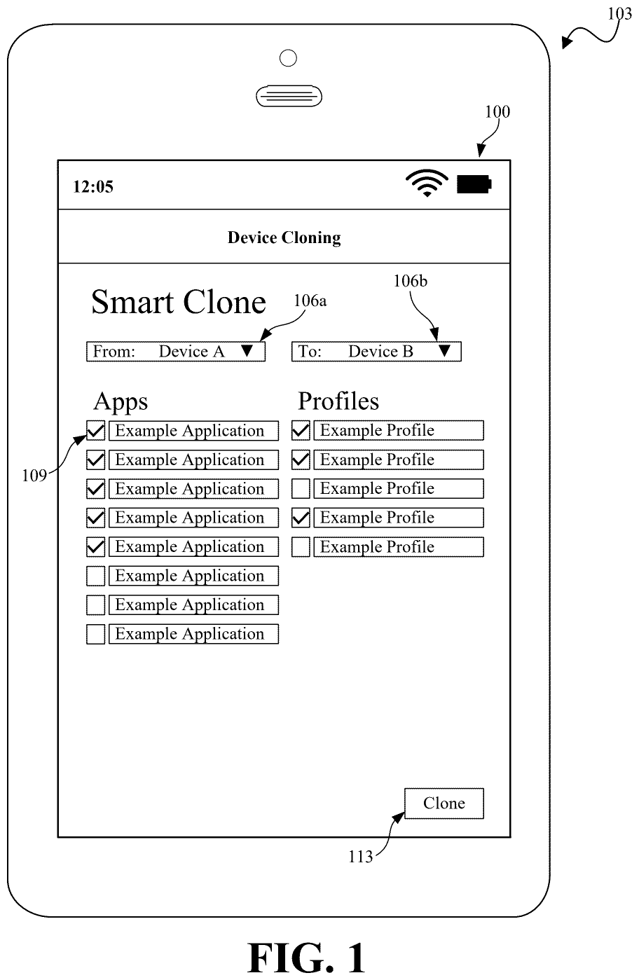

With reference to FIG. 1, shown is an example user interface 100 of a client device 103 according to various embodiments of the present disclosure. The user interface 100 can be presented to a user who has initiated the cloning process between a first client device 103a (“Device A”) and a second client device 103b (“Device B”). The example user interface 100 of FIG. 1 shows a first drop-down menu 106a where a user can select the device to be cloned (e.g., Device A). Similarly, the user interface 100 can include a second drop-down menu 106b for a user to select the device receiving the clone (e.g., Device B). In some embodiments, each client device 103 which populates in the drop-down menus 106a, 106b is registered to the same user. Once a first client device 103a has been selected, the user interface 100 can present various data obtained from the first client device 103a, such as applications (“Apps” list in FIG. 1), profiles (“Profiles” list in FIG. 1) certificates, settings, or other features which are installed on the first client device 103a.

As shown in FIG. 1, there can be an interactive user interface element 109 for each application, profile, or other feature line item. The user interface elements 109 can be checkboxes, radio buttons, toggles, or other user interface elements. The user can interact with the user interface elements 109 to select one or more preferred features to be cloned onto the second client device 103b. Once the preferred features have been selected, the user can select a “clone” option 113, or other user interface element to initiate the cloning process.

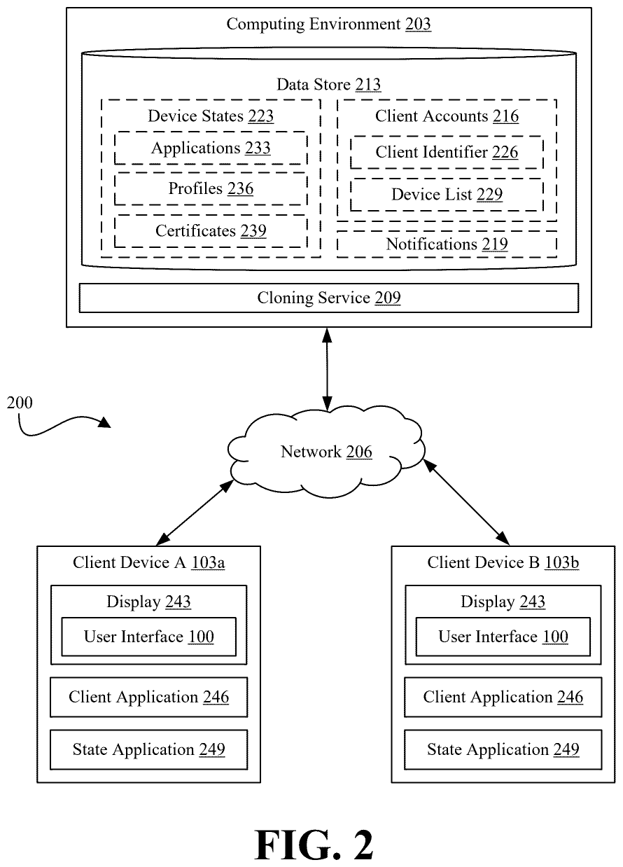

Moving next to FIG. 2, shown is a network environment 200 according to various embodiments. The network environment 200 can include a computing environment 203 and one or more client devices 103a, 103b, which can be in data communication with each other via a network 206.

The network 206 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 206 can also include a combination of two or more networks 206. Examples of networks 206 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource, or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a cloning service 209, and other applications, services, processes, systems, engines, or functionality not discussed in detail herein.

The cloning service 209 can be executed to identify the features to be cloned from a first client device 103a and push those features to the second client device 103b to complete the clone. According to various examples, the cloning service 209 can be operated by an issuer of a client account (e.g., an enterprise, employer, etc.). The cloning service 209 can be executed to register a new a client device 103, to obtain a device state from a first client device 103a, and to push selected features from the first client device 103a to a second client device 103b, as well as other functionalities. Other functionalities can also be provided in various other implementations.

Also, various data is stored in a data store 213 that is accessible to the computing environment 203. The data store 213 can be representative of a plurality of data stores 213, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 213 is associated with the operation of the various applications or functional entities described below. This data can include client accounts 216, notifications 219, device states 223, and potentially other data.

Client accounts 216 can be representative of any user account or profile associated with an enterprise or organization. As stored in the data store 213, the client accounts 216 can include various other data such as a client identifier 226, a device list 229, client settings and permissions, account type, and potentially other data. A client identifier 226 can represent any identifier which is unique to the client such as a token, username, account number, or other identifier. The client identifier 226 can be used in various messages, notifications, prompts, and other communications to identify the client account 216. Additionally, the device list 229 can be representative of a list of all devices registered to a particular client account 216. In some examples, the device list 229 can include device identifiers for each client device 103 associated with a client account 216. The device list 229 can be updated as old client devices 103 are removed and new client devices 103 added.

Notifications 219 can be representative of alerts, indications, prompts, messages, or other notices which can be sent to client devices 103. The notifications 219 can include informative messages which can be used to inform a client that a client device 103 was successfully registered, that cloning has initiated, that one or more features were successfully installed, that a device list 229 has been updated, that a device state 223 has been obtained, etc. According to various examples, notifications 219 can include prompts which can be used to ask a user to perform an action such as indicate acknowledgement, make a selection, or enter a response.

Device states 223 can be representative of a report about the various aspects of the configuration state of a client device 103. Device states 223 can include data about the applications 233, profiles 236, certificates 239, settings, or other features. In some embodiments, a device state 223 can include the features which the user has added or changed since the client device 103 was initially configured. In some embodiments, the device states 223 include telemetric data or other usage data from the client device 103 which can be used to order suggested features in a prompt to select one or more preferred features. Applications 233 can be representative of any program or software designed to run on the client device 103. Profiles can be representative of any combination of configuration settings, options, and features which are included on the client device 103. In addition, certificates 239 can be representative of any certificate which can be used to verify the identity of a client device 103 and enable secure authentication. In some embodiments, certificates 239 can be issued by an enterprise or organization which issued the client account 216.

The client device 103 is representative of a plurality of client devices (e.g., 103a, 103b, etc.) that can be coupled to the network 206. The client device 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 103 can include one or more displays 243, such as liquid crystal displays (LCDs), gas plasma-based flat panel displays, organic light emitting diode (OLED) displays, electrophoretic ink (“E-ink”) displays, projectors, or other types of display devices. In some instances, the display 243 can be a component of the client device 103 or can be connected to the client device 103 through a wired or wireless connection.

The client device 103 can be configured to execute various applications such as a client application 246 or other applications. The client application 246 can be executed in a client device 103 to access network content served up by the computing environment 203 or other servers, thereby rendering a user interface 100 on the display 243. To this end, the client application 246 can include a browser, a dedicated application, or other executable, and the user interface 100 can include a network page, an application screen, or other user mechanism for obtaining user input. The client device 103 can be configured to execute applications beyond the client application 246 such as email applications, social networking applications, word processors, spreadsheets, or other applications.

Additionally, other applications can be executed on the client device 103 such as a state application 249. The state application 249 can be executed to generate and report the device state 223 of the client device 103. In some examples, the state application 249 can be executed to receive and install various selected features such as applications 233, profiles 236, certificates 239, settings, or other features.

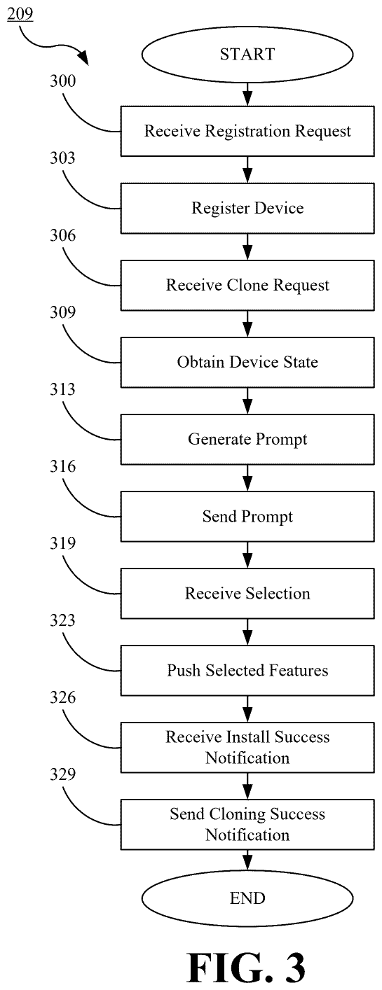

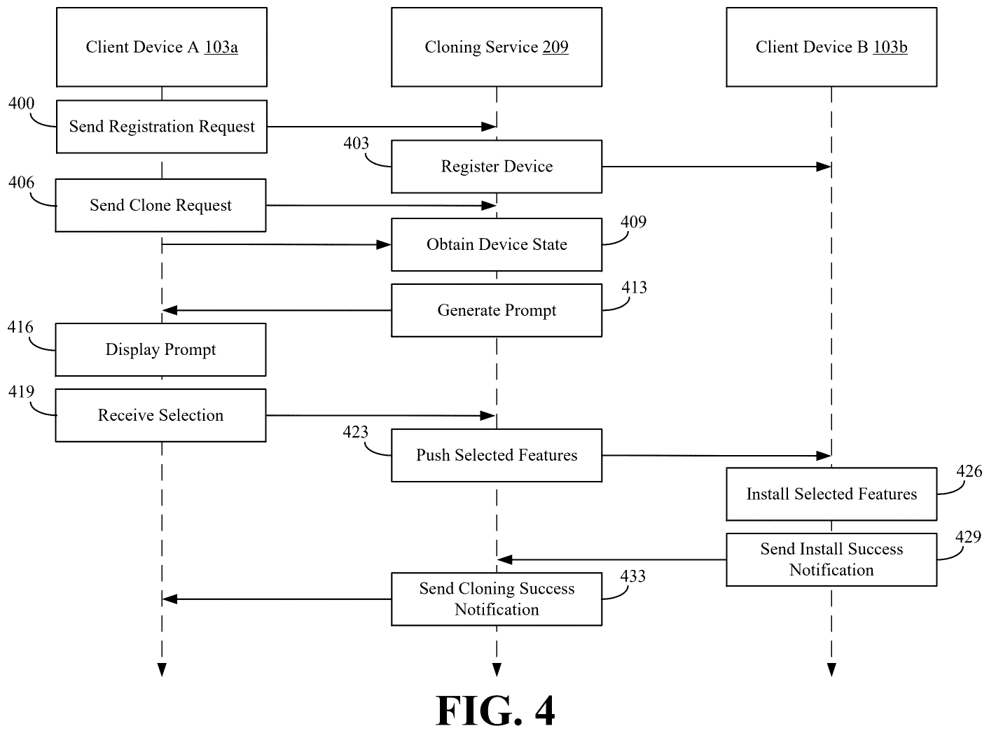

Next, a general description of the operation of the various components of the network environment 200 is provided. Although the following description provides merely an example of the operation of the various components of the network environment 200, other interactions and operations can also be performed by the various embodiments of the present disclosure. More detailed description of the operation of individual components is illustrated in the flowcharts of FIGS. 3 and 4.

To begin, a user can login to their client account 216 with an enterprise. In some embodiments, the user logs in from a first client device 103a. The user can register a new client device 103b to the client account 216. Once the new client device 103b has been registered, the user can initiate a clone request to transfer their preferred features from the first client device 103a to the new client device 103b. A user interface 100, such as the user interface 100 described in FIG. 1, can be presented to the user. The user can interact with the various user interface elements 109 to identify which devices to use for the cloning process, to select their preferred features, and to initiate the cloning process. The state applications 249 of the old client device 103a and new client device 103b can work with the cloning service 209 to obtain the device state 223 from the old client device 103a and push the preferred features to the new client device 103b. According to various examples, if the device which a user wishes to clone has been lost or damaged, the user can use a third client device 103c or guest device to initiate the cloning process. Similarly, according to various examples, a user could initiate the cloning process from the new client device 103b.

Referring next to FIG. 3, shown is a flowchart that provides one example of the operation of a portion of the cloning service 209. The flowchart of FIG. 3 provides merely an example of the many different types of functional arrangements that can be employed to implement the operation of the depicted portion of the cloning service 209. As an alternative, the flowchart of FIG. 3 can be viewed as depicting an example of elements of a method implemented within the network environment 200.

To begin, at block 300, the cloning service 209 can be executed to receive a registration request. The cloning service 209 can receive the registration request from a client device 103, a data store 213, or other system, service, or application in the network environment 200. The registration request can include information such as a device identifier for a new client device 103b, a client account identifier, or other information. In some examples, the cloning service 209 can receive the registration request in response to sending a prompt to add a new device.

At block 303, the cloning service 209 can be executed to register a device. In some embodiments, the cloning service 209 can register a client device 103 to a client account 216 in response to receipt of a registration request received at block 300. The cloning service 209 can, for example, determine the device identity from the registration request received at block 300, as well as determine the client account 216 based at least in part on the registration request. The cloning service 209 can use this information to register the client device 103.

At block 306, the cloning service 209 can be executed to receive a clone request. The cloning service 209 can receive the clone request from a client device 103, a data store 213, or other system, service, or application in the network environment 200. In some embodiments, the clone request can include a device identifier for a first client device 103a, a device identifier for a second client device 103b, or other information. In some examples, the clone request can include identifiers for a list of preferred features which are to be cloned from the first client device 103a to the second client device 103b. The cloning service 209 can receive a clone request in response to sending a prompt to clone the new client device 103b registered at block 303.

Moving now to block 309, the cloning service 209 can be executed to obtain a device state 223. The cloning service 209 can obtain a device state 223 from a client device 103, a data store 213, or another system, service, or application of the network environment 200. In some embodiments, the cloning service 209 can obtain a device state 223 by communicating with a state application 249 of a first client device 103a. The cloning service 209 can obtain the device state 223 of a client device 103 in response to receipt of the clone request at block 306. According to various examples, the cloning service 209 can determine the client device 103 from which to obtain the device state 223 based at least in part on a client device identifier included in the clone request received at block 306.

Next, at block 313, the cloning service 209 can be executed to generate a prompt. The cloning service 209 can generate a prompt which presents some or all of the state features identified in a device state 223 obtained at block 309. The prompt can include instructions to select one or more preferred features from the plurality of state features to clone from the first client device 103a to the second client device 103b. In some embodiments, the cloning service 209 can use a notification 219 as a template for generating the prompt. According to various examples, the cloning service 209 can generate the prompt in response to obtaining the device state at block 309.

At block 316, the cloning service 209 can be executed to send a prompt to a client device 103. In some embodiments, the cloning service 209 sends the prompt generated at block 313 to the first client device 103a from which a clone request was received (see block 306). In some embodiments, the cloning service 209 sends the prompt generated at block 313 to the second client device 103b. The cloning service 209 can determine where to send the prompt based at least in part on the client device 103 which originated the clone request received at block 306. In some embodiments, the cloning service 209 sends the prompt to a data store 213, or other system, service, or application in the network environment 200.

Next, at block 319, the cloning service 209 can be executed to receive a selection of one or more preferred features. In some embodiments, the cloning service 209 can receive the selection of one or more preferred features in the form of a message, prompt, or other notification 219 from a client device 103. In some embodiments, the cloning service 209 can receive the selection from the state application 249, the client application 246, or another application on the client device 103.

At block 323, the cloning service 209 can be executed to push the selected features to the new client device 103b. In some embodiments, the cloning service 209 can determine which state features to push based at least in part on the selection of preferred features received at block 319. According to various examples, the cloning service 209 can push the features to the client device 103 which was registered at block 303. The cloning service 209 can push the applications 233/application IDs, profiles 236, certificates 239, settings, or other features in the form of a cloning package which can be received and installed by a client device 103.

At block 326, the cloning service 209 can be executed to receive an install success notification 219. The install success notification 219 can notify the cloning service 209 that the selected features which were pushed to the client device 103 at block 323 were successfully installed or configured on the client device 103. In some embodiments, the cloning service 209 can receive the install success notification 219 from the state application 249 on the client device 103 where the selected features were installed. In some embodiments, the cloning service 209 can receive the install success notification from another device, system, service, or application in the network environment 200.

Next, at block 329, the cloning service 209 can be executed to send a cloning success notification 219 to a client device 103. The cloning success notification 219 can be representative of a message, alert, indicator, or other notice that the features selected at block 319 were successfully installed on the new client device 103b and that the cloning process is complete. In some embodiments, the cloning success notification 219 is generated based at least in part on a notification 219 obtained from the data store 213 in the network environment 200. In some embodiments, the cloning success notification is generated and sent in response to receipt of the install success notification 219 at block 326. The cloning service 209 can send the cloning success notification 219 to the client device 103 from which the clone request was received at block 306. In some embodiments, the cloning service 209 can send the cloning success notification to multiple client devices 103a, 103b in the network environment 200. After block 329, the flowchart of FIG. 3 comes to an end.

Turning now to FIG. 4, shown is a sequence diagram illustrating one example of interactions between multiple client devices 103a, 103b and the cloning service 209 according to various embodiments. It is understood that the sequence diagram of FIG. 4 provides merely an example of the many different types of functional arrangements that can be employed to implement the operation of the interactions between the client devices 103a, 103b and the cloning service 209. As an alternative, the sequence diagram of FIG. 4 can be viewed as depicting an example of elements of a method implemented within the network environment 200 (FIG. 2) according to one or more embodiments.

Beginning with block 400, the client device 103a can send a registration request to the cloning service 209. As described in the discussion of block 300 of FIG. 3, the registration request can include information such as a device identifier for a new client device 103b, a client account identifier, or other information. In some examples, the client device 103a can send the registration request to the cloning service 209 in response to receiving a prompt to add a new device. While FIG. 4 depicts the first client device 103a sending the registration request, the registration request can be sent to the cloning service 209 from the new client device 103b in various examples.

At block 403, the cloning service 209 can register the new client device 103b. As described in the discussion of block 303 of FIG. 3, the cloning service 209 can register the new client device 103b to a client account 216 identified in the registration request received at block 400. In some embodiments, the new client device 103b is registered automatically in response to receipt of the registration request. The cloning service 209 can identify the new client device 103b to register based at least in part on the information in the registration request.

Moving to block 406, the first client device 103a can send a clone request to the cloning service 209. While FIG. 4 shows the first client device 103a sending the clone request to the cloning service 209, the clone request can be sent by the new client device 103b or another device, system, service, or application in the network environment 200. As described in the discussion of block 306 of FIG. 3, the clone request can include identifiers for the client devices 103a, 103b which should be used in the cloning process as well as potentially include identifiers for a list of preferred features which are to be cloned from the first client device 103a to the second client device 103b.

At block 409, the cloning service 209 can obtain the device state 223 from the client device 103a to be cloned. While FIG. 4 depicts the cloning service 209 actively pulling the device state 223 from the client device 103a, it is understood that the cloning service 209 can, in some embodiments, send a request for the device state 223 to the state application 249 on the client device 103a and receive the device state 223 in response to the request. According to some examples, the device state 223 is sent to the cloning service 209 along with the clone request sent at block 406. In some embodiments, the cloning service 209 obtains the device state 223 to initiate the cloning process.

At block 413, the cloning service 209 can generate a prompt. As described in the discussion of blocks 313 and 316 of FIG. 3, the cloning service 209 can generate and send a prompt to the client device 103a. The prompt can include information about the device state 223 obtained at block 409. In some embodiments, the cloning service 209 sends the prompt to whichever the client device 103 sent the clone request at block 406.

At block 416, the client device 103a can be configured to display the prompt. The client device 103a which receives the prompt, sent from the cloning service 209 at block 413, can cause the prompt to be displayed in user interface 100 on a display 243 of the client device 103a. In some embodiments, the prompt is displayed in the user interface 100 as depicted in FIG. 1. The prompt can include one or more lists of features from the device state 223 obtained at block 409. Additionally, the prompt as displayed can include interactive user interface elements 109 and, in some embodiments, instructions to a user asking for a selection of one or more preferred features.

At block 419, the client device 103a can receive a selection of one or more preferred features from the list presented in the prompt. In some embodiments, the client device 103a can receive the selection through one or more user interactions with the user interface elements 109 in the user interface 100 as depicted in FIG. 1. However, other user interactions could also indicate a selection. Once a selection has been received, the client device 103a can send the selection to the cloning service 209.

Moving next to block 423, the cloning service 209 can identify the one or more preferred features from the selection and push the selected features to the new client device 103b. As described in the discussion of block 323 of FIG. 3, the cloning service 209 can push the features to the client device 103 which was registered at block 403. The cloning service 209 can push the applications 233/application IDs, profiles 236, certificates 239, settings, or other features received with the selection at block 419. These features can be pushed to the new client device 103b in the form of a cloning package.

At block 426, the new client device 103b can receive the selected features pushed at block 423 and install the features. In some embodiments, the state application 249 of the client device 103b can identify application IDs, profiles 236, certificates 239, settings, or other features identified in the list of selected features and use various APIs to download and install the preferred features. In some embodiments, the state application 249 can configure the device state 223 of the new client device 103b according to the selected features.

At block 429, the new client device 103b can send an install success notification 219 to the cloning service 209. Once the install of the selected features at block 426 has been completed, the state application 249 of the new client device 103b can be executed to send a notification 219 to the cloning service 209 to inform the cloning service 209 that the install process was successful. As described in the discussion of block 326 of FIG. 3, the install success notification 219 can notify the cloning service 209 that the selected features which were pushed to the client device 103 at block 423 were successfully installed or configured on the new client device 103b.

Moving to block 433, the cloning service 209 can send the cloning success notification 219 to the first client device 103a. While depicted in FIG. 4 as sending the cloning success notification 219 to the first client device 103a, the cloning service 209 can send the cloning success notification 219 to whichever client device 103 sent the clone request. In some embodiments, the cloning service 209 can send the cloning success notification to both the first client device 103a and the new client device 103b, as well as potentially other devices, systems, services, or applications in the network environment. As described in the discussion of block 329 of FIG. 3, the cloning success notification 219 can be representative of a message, alert, indicator, or other notice that the features selected at block 419 were successfully installed on the new client device 103b and that the cloning process is complete. In some embodiments, the cloning success notification 219 is generated and sent in response to receipt of the install success notification 219 at block 429. After block 433, the sequence diagram of FIG. 4 comes to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor and a memory; and
machine-readable instructions stored in the memory that, when executed by the processor, cause the computing device to at least:
obtain a device state of a first device, the device state including a plurality of state features;
generate a prompt to select one or more preferred features from the plurality of state features;
receive a selection of one or more preferred features; and
push the one or more preferred features to a second device.

2. The system of claim 1, wherein the machine-readable instructions cause the computing device to obtain the device state in response to receipt of a clone request to clone the device state onto the second device.

3. The system of claim 1, wherein the machine-readable instructions further cause the computing device to at least:
receive a registration request for the second device, the registration request comprising at least a client identifier; and
register the second device to a client account associated with the client identifier and the first device.

4. The system of claim 1, wherein the machine-readable instructions further cause the computing device to at least send to the first device the prompt to select one or more preferred features.

5. The system of claim 1, wherein the machine-readable instructions further cause the computing device to at least send to the second device the prompt to select one or more preferred features.

6. The system of claim 1, wherein the machine-readable instructions further cause the computing device to at least:
receive an installation success notification indicating that the one or more preferred features were successfully installed on the second device; and
send a cloning success notification to the first device.

7. The system of claim 1, wherein the one or more preferred features comprises one or more applications, profiles, or certificates identified in the device state of the first device.

8. A method, comprising:
obtaining, by a computing device, a device state of a first device, the device state including a plurality of state features;
generating, by the computing device, a prompt to select one or more preferred features from the plurality of state features;
receiving, by the computing device, a selection of one or more preferred features; and
pushing, by the computing device, the one or more preferred features to a second device.

9. The method of claim 8, wherein the device state is obtained in response to receiving, by the computing device, a clone request to clone the device state onto the second device.

10. The method of claim 8, further comprising:
receiving, by the computing device, a registration request for the second device, the registration request comprising at least a client identifier; and
registering, by the computing device, the second device to a client account associated with the client identifier and the first device.

11. The method of claim 8, further comprising sending the prompt to the first device to select one or more preferred features.

12. The method of claim 8, further comprising sending the prompt to the second device to select one or more preferred features.

13. The method of claim 8, further comprising:
receiving, by the computing device, an installation success notification indicating that the one or more preferred features were successfully installed on the second device; and
sending, by the computing device, a cloning success notification to the first device.

14. The method of claim 8, wherein the one or more preferred features comprises one or more applications, profiles, or certificates identified in the device state of the first device.

15. A non-transitory, computer-readable medium, comprising machine readable instructions that, when executed by a processor of a computing device, cause the computing device to at least:
obtain a device state of a first device, the device state including a plurality of state features;
generate a prompt to select one or more preferred features from the plurality of state features;
receive a selection of one or more preferred features; and
push the one or more preferred features to a second device.

16. The non-transitory, computer-readable medium of claim 15, wherein the machine-readable cause the computing device to obtain the device state in response to receipt of a clone request to clone the device state onto the second device.

17. The non-transitory, computer-readable medium of claim 15, wherein the machine-readable instructions further cause the computing device to at least:
receive a registration request for the second device, the registration request comprising at least a client identifier; and
register the second device to a client account associated with the client identifier and the first device.

18. The non-transitory, computer-readable medium of claim 15, wherein the machine-readable instructions further cause the computing device to at least send the prompt to select one or more preferred features to the first device.

19. The non-transitory, computer-readable medium of claim 15, wherein the machine-readable instructions further cause the computing device to at least send the prompt to select one or more preferred features to the second device.

20. The non-transitory, computer-readable medium of claim 15, wherein the machine-readable instructions further cause the computing device to at least:
receive an installation success notification indicating that the one or more preferred features were successfully installed on the second device; and
send a cloning success notification to the first device.
